(19) United States
(12) Patent Application Publication
(10) Pub. No.: US 2021/0264412 A1
(43) Pub. Date: Aug. 26, 2021

(54) SYSTEM AND METHOD FOR SECURING FINANCIAL TRANSACTIONS

(71) Applicant: Toshiba TEC Kabushiki Kaisha, Shinagawa-ku (JP)

(72) Inventor: Silvy WILSON, Rancho Santa Margarita, CA (US)

(21) Appl. No.: 16/798,850

(22) Filed: Feb. 24, 2020

(51) Int. Cl. G06Q 20/38; G06Q 20/40; G06Q 20/32; G06Q 20/34

(52) U.S. Cl. CPC G06Q 20/385; G06Q 20/40145; G06Q 2220/00; G06Q 20/3226; G06Q 20/341; G06Q 20/3823

(57) ABSTRACT

A system and method for verification of credit or debit transactions during user purchases includes a cloud server that receives charge information during an attempted sales transaction. The cloud server searches for contact information for a user that has been pre-associated with the account. A one-time code is generated and transmitted to the user's device. The user verifies the charge information and inputs the one-time code confirming the transaction. The one-time code may be encrypted or viewable in conjunction with the user's scanned fingerprint.

### TECHNICAL FIELD

This application relates generally to securing purchases made with a credit card. The application relates more particularly to use of confirming transactions biometrically and via transaction confirmation via devices that have been pre-associated with a user's account information.

### BACKGROUND

There is an ongoing transition away from using cash for purchases. Most purchases today are completed with a credit or debit card. Card purchases may be at a retail outlet via a point-of-sale terminal. A user may present their card to a sales associate who scans a magnetic strip or uses a chip reader to read an embedded chip to acquire account information. A check may be made with a financial institution, such as a bank or credit agency, to determine whether there are sufficient funds available to make a purchase. Once a purchase is approved, the sale is completed and the user's account balance adjusted accordingly. In other situations, a user makes their purchase online, such as via a website or telephone call with a sales associate. In these instances, the user may supply their credit or debit account information directly.

If a user's credit or debit card is lost or stolen, there can be a risk that it will be used by another fraudulently. A card, such as a debit card, may be associated with a personal information number (PIN) where a code, such as a four digit code, must also be supplied to complete a transaction. A user's PIN can be discovered or intercepted. In an online credit transaction, secondary information, such as a card identification (CID) code may need to be supplied. However, this information is readily apparent to one in possession of an actual card.

### BRIEF DESCRIPTION OF THE DRAWINGS

Various embodiments will become better understood with regard to the following description, appended claims and accompanying drawings wherein:

FIG. 1 is an example embodiment of a merchant transaction verification system;

FIG. 2 is an example embodiment of a digital device, such as smartphone or tablet computer;

FIG. 3 is a flowchart of a first example embodiment of a financial transaction verification system; and

FIG. 4 is a flowchart of a second example embodiment of a financial transaction verification system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

During credit or debit transactions, use of a static PIN bears risks of a third party intercepting the code, freeing them up to make fraudulent transactions. In example embodiments disclosed herein, a static PIN is replaced or supplemented with a one-time use PIN that is generated for a financial transaction and communicated to a portable user device that has been pre-associated with a user's account information. When making a credit or debit transaction, the user's account information is received and communicated to a server which returns a one-time PIN to the user's device. The user reads the newly generated PIN and enters it to confirm authenticity of the transaction.

Another example embodiment provides still further security and addresses a situation such as when a third party acquires both a user's credit card and smartphone. Both may be, for example, stored in a purse that is lost or stolen. A one-time PIN sent to the smartphone could then be available to the third party, allowing them to still complete a fraudulent transaction. In this example embodiment, the one-time PIN is decoded and displayed only when the user supplies appropriate fingerprint information through a fingerprint scanner associated with a point of sale (POS) terminal or their portable data device. In another further example, the PIN can be encrypted or decrypted associatively with the user's fingerprint information.

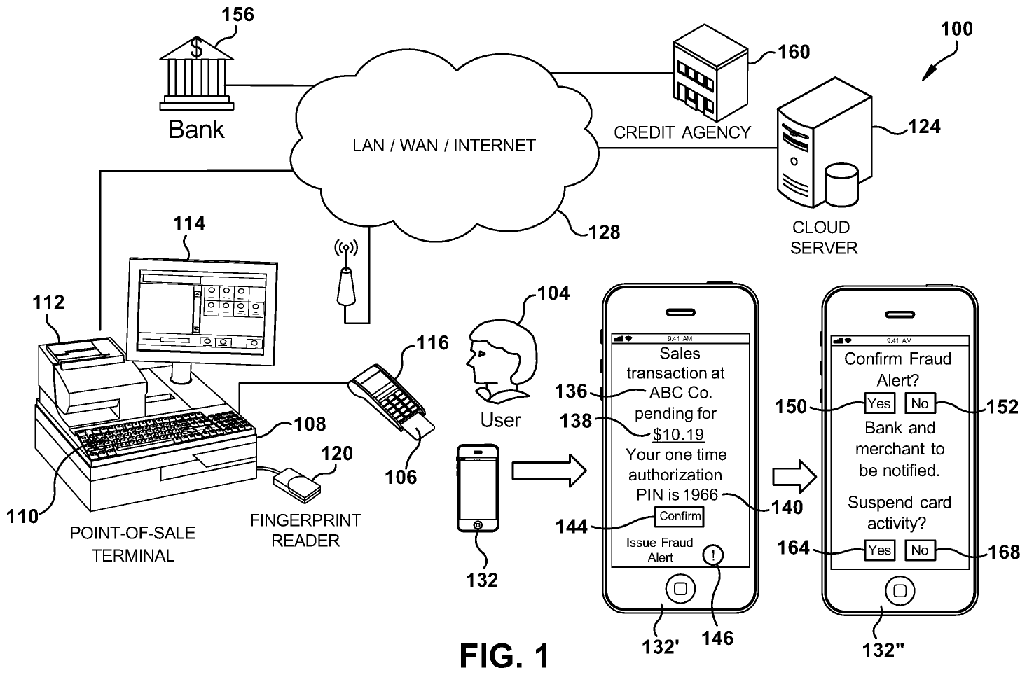

In accordance with the subject application, FIG. 1 illustrates an example embodiment of a merchant transaction verification system 100. In the example, user 104 wishes to undertake a purchase using their financial account, such as by making a credit or debit card purchase. The user may do their purchase transaction at a POS location, suitably with POS terminal 108. POS terminal 108 includes an embedded computer and an input/output (I/O) interface including keyboard 110, printer 112 and display 114. POS terminal 108 is also associated with a credit card unit 116, suitably comprising a keypad, a magnetic card reader and a chip reader. In a purchase transaction, the payment amount is calculated and displayed, and the user 104 inserts or swipes their credit or debit card 106 to commence payment. In an alternative example, the user or seller manually inputs account information. This may also be done by the user for an online transaction wherein they supply information directly, such as on a purchasing website. In such instances, the user may initiate their transaction on any suitable web enabled device, including smartphone 132.

The user's account information, such as credit or debit card information, is communicated to cloud server 124 through network cloud 128, suitably comprised of a local area network (LAN), a wide area network (WAN) which may comprised the Internet, or any suitable combination thereof. Cloud server 124 stores customer account information, including that of user 104, associatively with address information for digitally contacting a user device pre-associated with the user. Address information may be a cell phone number for sending a text or the user's email address. Cloud server 124 also suitably stores information for the user's fingerprint.

In a first example of FIG. 1, cloud server 124 sends user 104 a text or an email responsive to receipt of their account information. The text or email provides a one-time code, such as a one-time PIN to the user's device, such as a smartphone or tablet, illustrated with smartphone 132, generating smartphone display 132′. Display 132′ includes information, suitably identifying the seller at 136, transaction amount at 138, and provides a one-time PIN 140. If the user agrees, they can confirm the transaction by selecting touchscreen area 144, and the sales transaction is permitted to proceed. In the event that the attempted purchase is unauthorized, the user will be aware of the amount and the location where the fraudulent purchase is attempted. If a purchase attempt is unauthorized, the user may then issue a fraud alert, such as by selecting touchscreen area 146, suitably generating smartphone display 132″. A user may then confirm a fraud alert by selecting area 150 or choose not to confirm by selecting area 152. The user's bank 156 and credit agency 160 are suitably notified of the fraudulent attempt, including details about the transaction. The user may be provided with an opportunity to suspend further card activity by selecting area 164, or allow further transactions by selecting area 168.

In another example of FIG. 1, a user provides fingerprint information, such as by touching fingerprint sensor 120 associated with POS terminal 108, or by use of a fingerprint sensor integrated into smartphone 132. Fingerprint information is suitably required before a one-time PIN is displayed on the user's smartphone, preventing confirmation of transactions with stolen devices. Fingerprint information may be stored local on the user's device, or with cloud server 124. Cloud server 124 may also encrypt the one-time PIN code and decrypt it only when the user's fingerprint has been successfully scanned. In another example, encryption can be done using the user's stored fingerprint information such that the user's fingerprint is captured and used for decryption for even greater security.

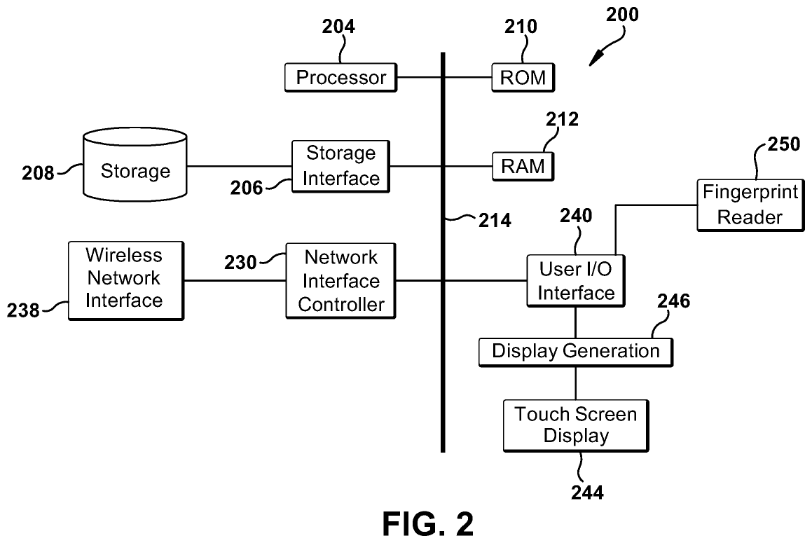

Turning now to FIG. 2, illustrated is an example of a digital device system 200 suitably comprising smartphone 132 of FIG. 1. Included are one or more processors, such as that illustrated by processor 204. Each processor is suitably associated with non-volatile memory, such as read only memory (ROM) 210 and random access memory (RAM) 212, via a data bus 214.

Processor 204 is also in data communication with a storage interface 206 for reading or writing to a data storage system 208, suitably comprised of a hard disk, optical disk, solid-state disk, or any other suitable data storage as will be appreciated by one of ordinary skill in the art.

Processor 204 is also in data communication with a network interface controller (NIC) 230, which provides a data path to any suitable network or device connection, such as a suitable wireless data connection via wireless network interface 238. A suitable data connection to a cloud is via a data network, such as a local area network (LAN), a wide area network (WAN), which may comprise the Internet, or any suitable combination thereof, as well as a cellular connection. A digital data connection is also suitably directly with devices, such as a POS terminal, via Bluetooth, optical data transfer, Wi-Fi direct, near field communication (NFC), or the like.

Processor 304 is also in data communication with a user input/output (I/O) interface 240 which provides data communication with user peripherals, such as touch screen display 244 via display generator 246, as well as keyboards, mice, track balls, touch screens, or the like. Connection is also suitably made with fingerprint reader 250. It will be understood that functional units are suitably comprised of intelligent units, including any suitable hardware or software platform.

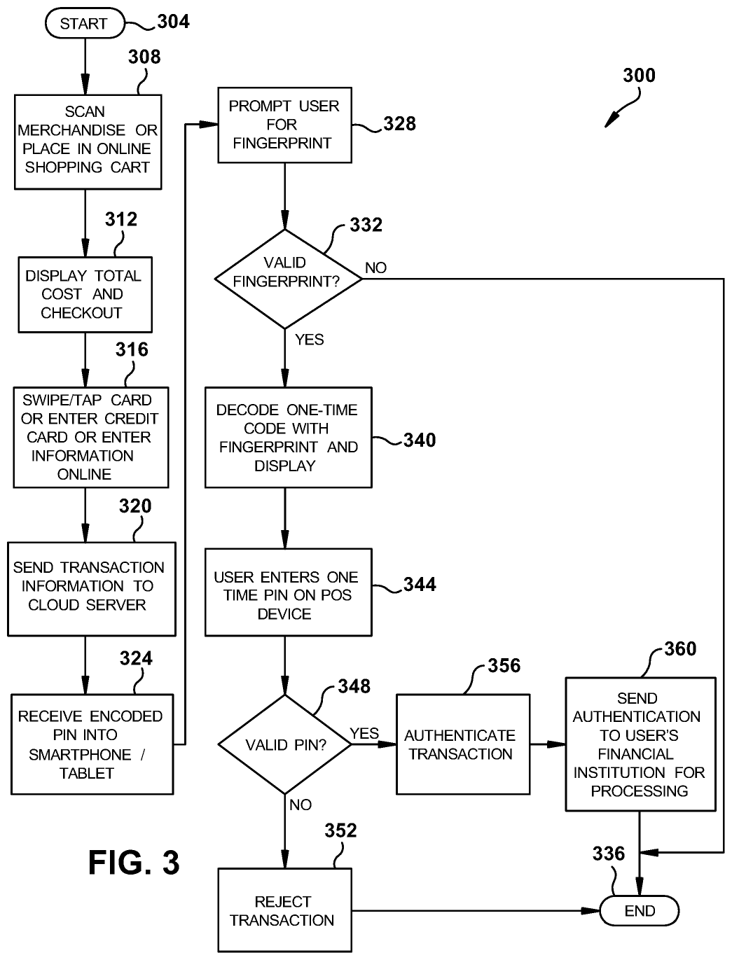

FIG. 3 is a flowchart 300 of an example embodiment of a financial transaction verification system. The process commences at block 304 and proceeds to block 308 wherein merchandise checked out, manually, via scanning, or from a user's online shopping cart. Next, the total cost is displayed at block 312, and account information for payment is entered at block 316. This information is sent to a cloud server at block 320, and a corresponding one-time code is received by the user's device at block 324. A user is prompted to enter fingerprint information at block 328, and if a valid fingerprint is not obtained at block 332, the process ends at block 336. If a proper fingerprint is received, an encrypted one-time code is decrypted and displayed on the user's device at block 340. The user enters this information, such as in a keyboard at a POS terminal or via their web browser, at block 344. If a valid PIN is not received at block 348, the transaction is rejected at block 352 and the process ends at block 336. If a valid pin is received, the transaction is authenticated at block 356, and the information is relayed to the user's financial institution for processing, such as to approve the amount and further authorize the transaction and update the user's account. The process then ends at block 336.

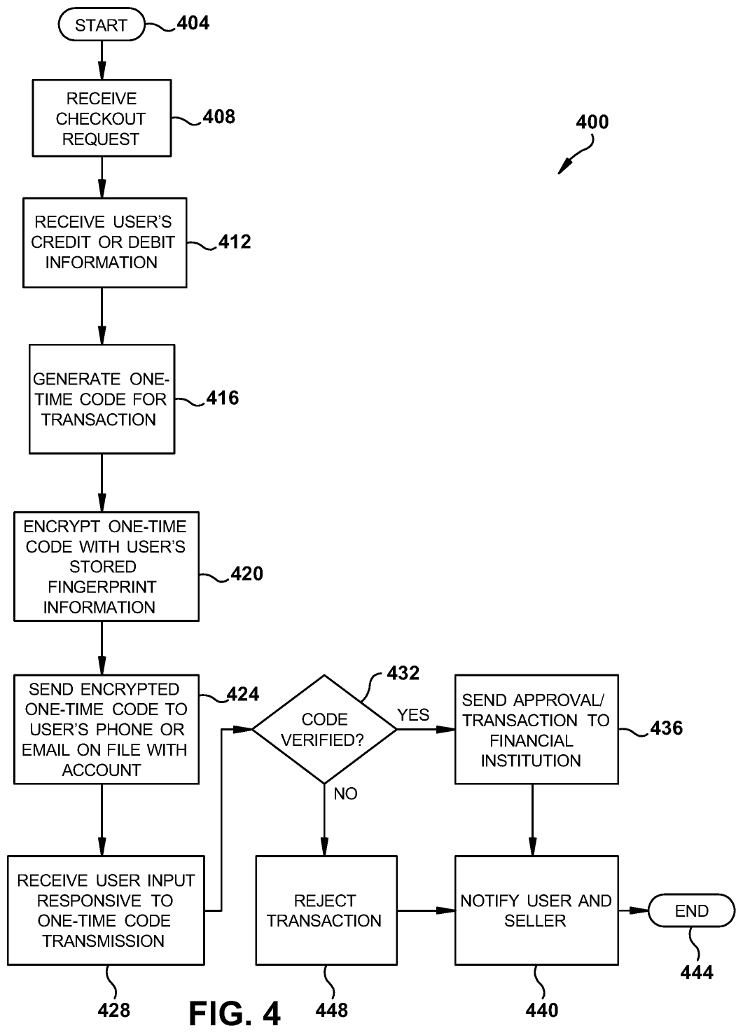

FIG. 4 is a flowchart 400 of an example embodiment of a financial transaction verification system. The process commences at block 404 and proceeds to block 408 where a checkout request is received. A user's credit or debit information is received at block 412, and a one-time code is generated at block 416. The code is suitably encrypted at block 420 and sent to a user's phone via text or email with pre-associated address information at block 424. The code is received at the user's device at block 428, and decrypted and/or fingerprint verified if needed at block 432 and, if verified, sent for further handling at one or more associated financial institution at block 436. Seller and user are suitably notified at block 440 before the process ends at block 444. If the one-time code is not verified at block 432, the transaction is reject ad block 448, the user and seller are so notified at block 440, and the process ends at block 444.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a memory storing user account information associatively with a user device address;
a data interface, and
a processor,
the processor configured to receive a checkout request for a credit or debit purchase via the data interface,
the processor configured to receive credit or debit card information corresponding to the credit or debit purchase from an associated user via the data interface,
the processor further configured generate a one-time code corresponding to the credit or debit purchase,
the processor further configured to encrypt the generated one-time code in accordance with a fingerprint of a user associated with a user device associated with the user device address,
the processor further configured to determine user account information from the received credit or debit card information,
the processor further configured to send the encrypted one-time code to a user device address associated with the determined user account information via the data interface,
the processor further configured to receive user input responsive to the sent one-time code via the data interface, and
the processor further configured to selectively approve the credit or debit purchase in accordance with a comparison of the one-time code with received user input, and
wherein the received user input is comprised of the one-time code decrypted on the user device in accordance with a user fingerprint scan completed on the user device.

2. The system of claim 1 wherein the user device is comprised of a smartphone or tablet, and wherein the user device address is a text message address or an email message address associated with the user device.

3. The system of claim 1 wherein the user account information is further stored associatively with fingerprint data corresponding to a fingerprint of the associated user, and wherein the processor is further configured to selectively approve the credit or debit purchase in accordance with a comparison of stored fingerprint data and fingerprint data received via the data interface.

4. The system of claim 1 wherein the processor is further configured to encrypt the one-time code.

5. (canceled)

6. (canceled)

7. The system of claim 1 wherein the processor is further configured to communicate an approved credit or debit purchase to an associated financial institution for processing.

8. A method comprising:
storing user account information associatively with a user device address in a memory;
receiving a checkout request for a credit or debit purchase via a data interface;
receiving credit or debit card information corresponding to the credit or debit purchase from an associated user via the data interface;
determining user account information from received credit or debit card information;
generating a one-time code corresponding to the credit or debit purchase;
encrypting the generated one-time code in accordance with a fingerprint of a user associated with a user device associated with the user device address,
sending the encrypted one-time code to a user device address associated with the determined user account information via the data interface; and
receiving user input responsive to the sent one-time code via the data interface; and
selectively approving the credit or debit purchase in accordance with a comparison of the one-time code with received user input; and
wherein the received user input is comprised of the one-time code decrypted on the user device in accordance with a user fingerprint scan completed on the user device.

9. The method of claim 8 wherein the user device is comprised of a smartphone or tablet, and wherein the user device address is a text message address or an email message address associated with the user device.

10. The method of claim 8 further comprising storing the user account information associatively with fingerprint data corresponding to a fingerprint of the associated user, and selectively approving the credit or debit purchase in accordance with a comparison of stored fingerprint data and fingerprint data received via the data interface.

11. The method of claim 8 further comprising encrypting the one-time code.

12. (canceled)

13. (canceled)

14. The method of claim 8 further comprising communicating an approved credit or debit purchase to an associated financial institution for processing.

15. A system comprising:
memory;
a data interface;
a user interface including a user input and a display configured to receive credit or debit account information from a user;
a fingerprint scanner;
a processor,
the processor configured to communicate received credit or debit account information to an associated server via the data interface, and
the processor further configured to receive an encrypted one-time code generated by the associated server responsive to communicated credit or debit account information via the data interface;
the processor further configured to decrypt the one-time code in accordance with user fingerprint data received from the fingerprint scanner; and
a portable data device associated with the user configured to receive and display the decrypted one-time code,
wherein the processor is further configured to receive user response code input associated with the displayed one-time code via the user input, and
wherein the processor is further configured to selectively process a credit or debit transaction in accordance with a comparison of the received one-time code with the received user response code input.

16. The system of claim 1 further comprising a fingerprint reader configured to capture a digitized fingerprint of the user, and wherein the one-time code is selectively displayed in accordance with a captured digitized fingerprint.

17. The system of claim 16 wherein the one-time code received into the portable data device is encrypted, and wherein the encrypted one-time code is decrypted in accordance with the captured digitized fingerprint.

18. The system of claim 17 wherein the fingerprint reader is integrated into the portable data device.

19. The system of claim 15 wherein the processor is further configured to generate an account alert when the received one-time code does not correspond to the user response code input.

20. The system of claim 15 wherein the user input includes a card scanner configured to read the credit or debit account information from a chip or magnetic strip on an associated card.
